(19) United States
(12) Patent Application Publication
(10) Pub. No.: US 2018/0157571 A1
(43) Pub. Date: Jun. 7, 2018

(54) METHOD FOR THE REALISTIC ESTIMATION OF FUNCTION RUN TIMES IN PIL SIMULATION

(71) Applicant: dSPACE digital signal processing and control engineering, Paderborn (DE)

(72) Inventors: Frank Lünstroth, Delbrück (DE); Sebastian Hillebrand, Marsberg (DE); Karsten Fischer, Paderborn (DE)

(21) Appl. No.: 15/735,487

(22) PCT Filed: Jun. 9, 2016
(86) PCT No.: PCT/EP2016/063114

§ 371 Date: Dec. 11, 2017

(30) Foreign Application Priority Data
Jun. 12, 2015 (EP) 15171801.2

(51) Int. Cl. G06F 11/30; G06F 11/34

(52) U.S. Cl. CPC G06F 11/3013; G06F 11/3457; G06F 2201/805; G06F 11/3466; G06F 2201/885; G06F 11/3419

(57) ABSTRACT

The invention relates to a method and device for determining a run time that is needed by a function of a control program for a control unit in a real-time system, executed on a target processor in a processor-in-the-loop (PIL) simulation, wherein the method includes the creation or loading of a graphical development model of the control unit in(to) a development environment, wherein the graphical development model maps the functionality of the control unit using function blocks or function symbols in the graphical development model; selection of at least one function block or function symbol within the graphical development model, particularly selection of a function block or function symbol via a graphical user interface; and automatic generation of the control program for execution on the target processor in accordance with the graphical development model, wherein the control program includes the function which maps the functionality of the selected function block or function symbol. Furthermore, a first run time measuring point associated with the start of the function and a second run time measuring point associated with the end of the function in the control program are inserted into the control program, and the cache of the target processor used for executing the function is put into a predetermined state directly prior to the first run time measuring point, and run time values from which the run time is determined are measured during the execution of the control program on the target processor at the first and second run time measuring points.

### FIELD OF THE INVENTION

The invention relates to the measurement and determination of run times of functions in a processor-in-the-loop (PIL) simulation.

### BACKGROUND OF THE INVENTION

As the use of embedded systems is increasing in numerous fields of technology for the execution of monitoring, control, or adjustment functions and/or data or signal processing, the respective coordination between control programs used and the hardware, particularly the processor used, has become an integral part of development processes. It is desirable in this context that the combination of control program and hardware can be tested at various development stages to be able to detect any problems in the execution of monitoring, control, or adjustment functions early and to adjust the hardware used or the respective functions.

Increasing use is made of model-based development tools for developing the control programs, e.g. software code for control units in the automotive industry, for instance for functional development or for creating or (simulatively) testing (parts) of a software architecture or an overall control program comprising software components for one or more controllers. Examples of development environments for functional development are, inter alia, Ascet from Etas, Labview from National Instruments, Simulink from The Mathworks or Targetlink from dSPACE. Examples of development environments for creating and/or testing a controller software architecture comprising software components, that is to say code components, for generating an executable overall control program are Autosar Builder from Dassault Systèmes, DaVinci Developer from Vector, Isolar from Etas, Rational Rhapsody from IBM, SystemDesk or VEOS from dSPACE or the like. Model-based development tools make it possible to specify the functionality of the control program at first graphically, in the form of models, typically as block diagrams or else with the aid of list or tree structures. The functionality is specified at a higher level of abstraction than specification at the level of text-based software code such as C code. On the one hand, this provides improved clarity about the functionality of the control program, on the other hand such models can be better reused since their higher level of abstraction gives them a more general character and they are not yet adapted in detail to implementation and/or programming. Other advantages when using model-based development tools include that they allow testing of the functionality of the models at a high level of abstraction, i.e. the model can be executed in so-called “model-in-the-loop” (MIL) tests and checked for errors of its functionality. Furthermore, a code generator can automatically generate code for a control program based on a model, such as C code that can run on a controller processor, or VHDL code for programming an FPGA or ASIC.

The generated code can then be tested in a next testing step. Testing the software code is also referred to as “software-in-the-loop” (SIL). The code is checked for errors in its functionality in that coding-specific properties and/or limitations are now also taken into account, for example the use of fixed-point rather than floating-point numbers. In another step, the code can also be executed on an external target processor. This case is referred to as a “processor-in-the-loop” (PIL) simulation in which processor-specific properties and/or limitations are taken into account as well, e.g. target compiler and processor clock rate.

A frequent first step of checking the functionality of the software code that is executed on the target processor is the generation of a so-called “instrumented program code” as a control program using the code generator and execution of the generated code. The instrumented code is not completely optimized but includes, for example, additional logging macros which are used to monitor during the test phase which program parts or functions are running or invoked how often and which values were calculated, e.g. for output variables. Such information, which the software developer obtains by recording data in test runs, is called “profiling or tracing information”. This profiling information can be transmitted to a connected PC where it is available for analysis and evaluation purposes.

Estimating run time information, that is, the time the processor needs to execute a control program, is of particular interest. Particularly, estimating the ‘worst case’ scenario, that is, the longest run time, can be essential for obtaining a guaranteed response or reaction time, particularly for controllers that control safety-relevant routines in real time, e.g. an anti-lock braking system or airbag in a car.

The execution times of control programs depend substantially on memory access times. Modern processors, which need fast data processing, are therefore equipped with memory caches. Caches are intermediate memories in or near the processor core that buffer the last data and commands processed from the main memory (RAM/flash/ROM) and in this way enable their fast reuse, e.g. when identical code parts are executed repeatedly in a loop.

Since cache size is limited due to chip manufacturing costs, the available memory is typically insufficient for loading the instructions of all tasks, functions, and/or data ‘next to one another’ and thus permanently in the cache. To enable a guaranteed or at least optimized response time of the (time) critical functions, functions in real-time systems often continue to be prioritized, and functions with a low priority can be paused if a function with a higher priority is to be calculated urgently. This is sometimes called a task switch.

DE 10034459 A1 describes a method for measuring the run time of a task taking into account task switches which occur. A timer is started for each task and halted at each switch of the priority level and only allowed to continue when the task is resumed in the original priority level.

It can happen during task switches and if functions/data are above the cache size that instructions and/or data that had already possibly been loaded into the cache before and are needed to execute a function are now no longer available and have to be reloaded from the memory into the cache. Reloading the necessary instructions and/or data thus takes place at the expense of the run time of a paused task, for example.

Reloading can also be required if the memory map in the cache is no longer current, that is, if it is inconsistent with the main memory. In such cases the cache is called invalid.

### BRIEF SUMMARY OF THE INVENTION

Simulations that are the subject matter of this application generally do not run in real time. There typically are not multiple tasks in SIL and in PIL simulations, in particular in development environments for functional development, so task switches do not occur. Furthermore, the simulated functionality of a model is often much smaller than the application on a controller used later (since these are typically component/unit tests), such that the entire program code may fit into the cache.

For obtaining a realistic estimation of the later run time in a real-time system, it is therefore desirable to determine the “best case”, that is, the time the processor needs to perform a single function exclusively which can utilize the entire cache for itself. On the other hand, the execution time for a function is to be measured in the “worst case”, when the cache is loaded or invalid and the instructions and data reflecting the functionality first have to be loaded into the cache and then executed.

Inserting measuring code in the function would change the cache of the CPU and falsify the measurement. Prior art thus knows for example the use of external trace/debug hardware connected to a PIL evaluation board, which performs measurements per hardware interface during the PIL simulation to measure functions exactly.

Alternatively, “worst case” run times are determined by statistical analysis (without a simulation). But these mostly deliver run times that are too high because they cannot detect dependencies between various (external) input variables.

It is the problem of the present invention to provide an improved method for estimating run times of individual functions of a control program, executed on a target processor.

This problem is solved by a method for determining a run time that is needed by a function of a control program for a control unit in a real-time system, executed on a target processor in a processor-in-the-loop (PIL) simulation, the method comprising:
Creation or loading of a graphical development model of the control unit in(to) a development environment, wherein the graphical development model maps the functionality of the control unit using function blocks or function symbols in the graphical development model;
Selection of at least one function block or function symbol within the graphical development model, particularly selection of a function block or function symbol via a graphical user interface;
Automatic generation of the control program for execution on the target processor in accordance with the graphical development model, wherein the control program includes the function which maps the functionality of the selected function block or function symbol.

The method operates such that a first run time measuring point associated with the start of the function and a second run time measuring point associated with the end of the function in the control program are inserted into the control program and wherein directly prior to the first run time measuring point the cache of the target processor used for executing the function is transformed into a predetermined state. The method further comprises the following steps:
Execution of the control program on the target processor, wherein run time values are measured at the first and second run time measuring points from which the run time is determined.

Within the present invention, a control unit is a functional unit of a controller, such that the term covers both an entire controller and an individual component of a controller. Functionalities of the control unit are represented by function blocks in a block diagram and/or by function symbols (graphical or textual) in a list or tree structure view in the graphical development model. The graphical development model may be, for example, a development model for functional development or, for instance, a development model for creating and/or testing a software architecture, wherein software components, that is to say software code for particular functionalities or functions, are combined in the model to form an (overall) control program for which a code generator generates the frame and communication code and the run-time environment. Function blocks or symbols can represent the complex functionality of a depicted control routine or can be assigned it in the form of program routines or software components. The function blocks or function symbols generally represent a subsystem of the mapped control unit. Such subsystems are implemented as higher-level functions in the executable program code of the control program for example. Function blocks or function symbols can also represent or be assigned subordinate functions which are implemented as sub functions within a functionality of the control unit in the executable control program. The automatically generated (overall) control program is created taking into account the properties of the respective target processor.

The disclosed system is based on the finding that, when determining the run time of a function within PIL simulations in model-based development, cache effects that occur in real-time systems but also in the later control unit application have to be taken into account to obtain a realistic estimation of the required run times and, where required, to be able to dimension the processor for the real-time control system accordingly or to be able to make early adjustments to the control routines. The disclosed system can be applied to any forms of models for model-based control unit development regardless of whether they are in the form of block diagrams, list or tree structures.

One advantage of the disclosed system is that the run time of any function within a control unit program can be determined for various, arbitrary cache states in the PIL simulation and that effects that can be expected to occur in the later real-time system can already be taken into account at an early development stage. Thus, the simulation of cache effects can be integrated at an early modeling stage to be able to simulate and measure their impact on the execution times of any desired functions within a control unit program code as part of a PIL simulation. Users of the disclosed system thus do not have to manipulate the executable program code on their own but can configure the run time measurement at the modelling stage. Furthermore, the method neither requires the purchase and connection of additional trace/debug hardware, nor is the processor cache strained by the necessary measuring program code, which would otherwise result in falsification of the measurements or run times, respectively, of the control unit program code to be measured compared to a run without measuring program code.

In a preferred embodiment of the disclosed system, the function is a sub function which is executed within a main function. While known systems can just measure the entire run time of a complete program sequence, the disclosed system makes it possible to also determine a realistic run time for individual sub functions. It is particularly the reloading of low-priority sub functions into the cache after being interrupted that can cause significant changes in run time in later real-time systems. A specific analysis down to the level of subordinate functions is therefore desirable to get a more detailed representation of the run time sequences and potential run time bottlenecks.

Another advantage results from always recording the measured values at the start and end of a function or sub function call. In addition to the execution times as such, the respective point in time can be also illustrated at which a sub function was calculated within the main function and which sub functions were called in a sub function. Since an execution time is also assigned to each calculation step, a mean execution time as well as maximum and minimum run times can be calculated.

In a first development of one of the embodiments of the disclosed system, the predetermined state reflects a partially loaded cache. A cache is partially loaded when a function, i.e. all instructions/data relevant for executing the function, have to be partially reloaded into the cache, which results in a run time delay.

In an alternative second development of one of the embodiments of the disclosed system, the predetermined state reflects an empty cache. This situation corresponds to the ‘worst case’ scenario which occurs when a function has to be loaded completely into the cache used.

In another development of one of the embodiments of the disclosed systems, memory space outside the cache is assigned to values to be measured at the run time measuring points. This ensures that the run time measurement is not falsified by storing the values.

In another development of the preferred embodiment of the disclosed systems, the partially loaded cache is mapped by statistical averaging over several simulation runs, wherein the cache is emptied completely before the function is called in just a subset of simulation runs.

In an alternative embodiment of the disclosed system, the partially loaded cache is mapped by inserting additional measuring code in the function to be measured. Depending on the amount of measuring code used in relation to cache accesses, this causes an additional cache load which can result in run time delays depending on the capacity of the cache used.

Another aspect of the disclosed system is a device for creating and executing a processor-in-the-loop simulation for determining a run time which is needed by a function of a control program for a control unit in a real-time system while executed on a target processor in the PIL simulation, wherein the device includes means for creating or loading a graphical development model of the control unit into a development environment, wherein the graphical development model maps the functionality of the control unit using function blocks and/or function symbols. The device further selects at least one function block or symbol within the graphical development model, particularly via a graphical user interface, and a code generator for automatic generation of the control program for execution on the target processor in accordance with the graphical development model, wherein the control program includes the function which maps the functionality of the selected function block or symbol. Furthermore, the device transfers the generated control program to the target processor, executes the control program on the target processor, and the code generator is configured to insert a first run time measuring point associated with the start of the function and a second run time measuring point associated with the end of the function into the control program and to put the cache of the target processor used for executing the function into a predetermined state directly prior to the first run time measuring point, wherein the device further comprises means for receiving and analyzing the values measured at the run time measuring points during the execution of the control program.

A user of the device can thus specify cache states for executing the control program and can perform or configure analyses regarding realistic run times as early as at the model stage without having to manually handle the control program code generated, which does not just require sufficient programming knowledge but also poses a risk of erroneous interventions and lacks reproducibility.

In a preferred embodiment, the device analyzes the run time measurements, particularly for graphical analysis, wherein analyzing the run time measurements are configured to annotate the function blocks or symbols in the original graphical development model with the analyzed run time values of the respective functions. A file that assigns the run time values to the respective function in the executed program code is generated for this purpose during the PIL simulation. The graphical user interface can be configured via another mapping between the function in the control program code and the function block or symbol in the graphical model to annotate the representation of the function blocks or function symbols with the run times and to store corresponding information in the graphical model.

### DESCRIPTION OF THE DRAWINGS

Preferred embodiments of the present invention are described as examples with reference to the enclosed figures.

FIG. 1 shows a model component of a control unit in a graphical model environment with various function blocks.

FIG. 2 shows pseudo code as it could be generated by the code generator based on the graphical model including inserted run time measuring function calls.

### DETAILED DESCRIPTION

The following description is meant to illustrate an exemplary embodiment of the present invention but does not have any further limiting character.

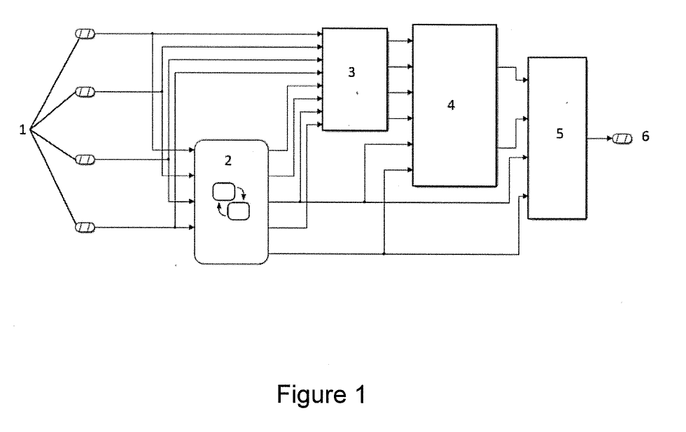

FIG. 1 is an example of a graphical model of a controller subsystem which controls a specific functionality of a controller in a graphical model environment. The input signals 1, which can originate from various sensors, are fed into the function block 2, a control logic, and the function block 3, a signal correction unit. The control logic 2 processes the input signals 1 and passes the processed signals on as input signals to the function block 3, a signal correction unit. This unit processes all input signals and passes them on to the function block 4, a calculation unit. The calculation unit 4 also receives input signals from the control logic 2. As the last unit in the subsystem of the controller model shown, the function block 5, a calculation unit, receives the output signals of the calculation unit 4 as well as two output signals of the control logic 2 and then calculates the output value of the subsystem 6.

To generate such a model, each unit can be selected using a graphical user interface and interconnected using input means such as a mouse/touch pad or a keyboard. Model developers can use a plurality of predefined function blocks or define their own function blocks by defining input and output data as well as the functionality of a function block or an entire subsystem. In modern model development environments, an executable program code that is optimized for the processors used in the later application can then automatically be generated from the defined graphical models.

Generated program code according to the exemplary model described above would consist of a main function for the control logic in which the sub functions would be called for the signal correction unit 3 and the calculation units 4 and 5. If a model developer wishes to analyze the run times of individual model units, he or she can select these units, for example, via a graphical user interface or a command line API. In a subsequent code generation step for the respective model for later application of the generated and compiled program code on a specific processor with a given capacity, the program code is equipped with run time measuring points which are associated with the start and end of the respective function call that corresponds to the selected function block.

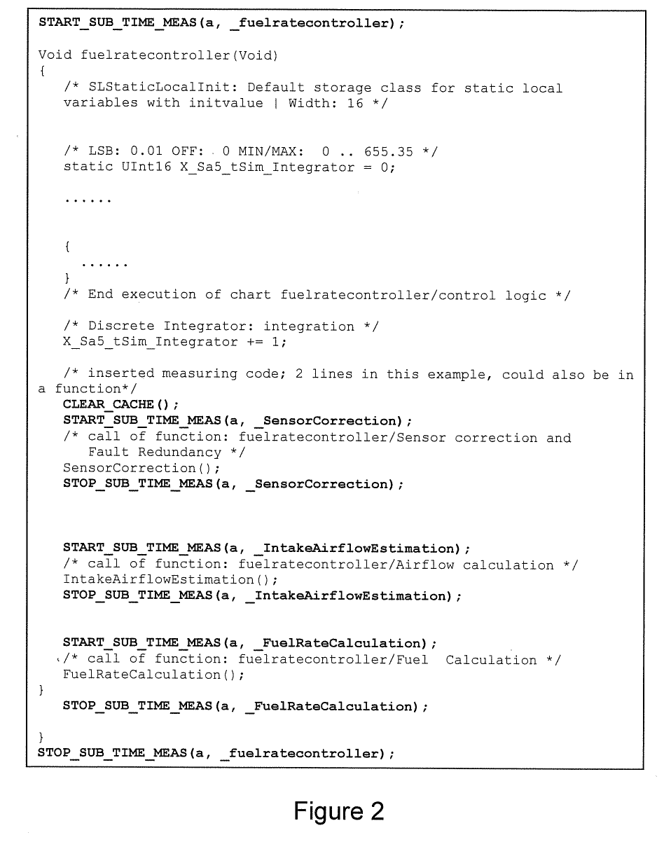

FIG. 2 shows exemplary program code which reflects the structure of the sample model with run time measuring points directly before and after the function calls.

The results of measurements are not stored in the cache used for executing the program code to prevent falsification of the run time measurement. This can be done either by freezing and thawing the cache using a specific processor instruction, or by linking the measuring time calls as a function to a memory not located in the cache if the processor does not offer the freezing/thawing functionality.

In this way, a cache-neutral run time of any desired model unit can be determined. This “bare” run time thus represents a ‘best case’ scenario in which the function has already been completely loaded into the cache and the run time is just made up of the calculation time.

Potential implementation could be in the form of logging macros which are advantageously implemented using preprocessor defines that are automatically deleted when the final program code is exported to the controller, particularly by redefining them as empty instructions or by removing their text from the source code.

For measuring the run time under cache load, a user can set the function block or function symbol in the model to empty the cache before the respective sub function is called. This can be done, for example by generating another macro that empties or invalidates the cache in the code directly before the function call.

The run time determined in this way reflects the ‘worst case’ scenario in which the instructions and data associated with a function have to be completely reloaded for each (simulation) step.

To simulate gradual cache loading, e.g. where other higher-priority tasks contribute to the load, a user can also set a cache load percentage at the function block or function symbol in the model. It can also be applied in a randomized manner during the simulation and thus clear/invalidate the cache before some (sub)function calls (e.g. cache is invalidated in every second run only). A user will then obtain an average run time for executing a specific function by averaging multiple PIL simulation runs.

Such gradual cache loading could also be simulated by additional measuring code in a (sub)function, e.g. inserted at the start of a long loop. It is further conceivable to distinguish between instruction and data cache in the above applications, that is, to invalidate/load them either both or just one or none of them to obtain an estimation as realistic as possible of the later run time performance.

In addition to the execution times as such, the present disclosed system with its run time measuring points associated with the function to be measured also makes it possible to illustrate the respective point in time at which a sub function was calculated within the main function and which other sub functions were called in a sub function. Since an execution time is also assigned to each calculation step, a mean execution time as well as maximum and minimum run times can be calculated.

1. A method for determining a run time that is needed by a function of a control program for a control unit in a real-time system, executed on a target processor in a processor-in-the-loop (PIL) simulation, the method comprising:
creating or loading of a graphical development model of the control unit in a development environment, wherein the graphical development model maps the functionality of the control unit using function blocks or function symbols in the graphical development model;
selecting at least one function block or function symbol within the graphical development model via a graphical user interface;
automatically generating the control program for execution on the target processor in accordance with the graphical development model, wherein the control program includes the function which maps the functionality of the selected function block or function symbol,
inserting a first run time measuring point associated with the start of the function and a second run time measuring point associated with the end of the function in the control program into the control program and wherein directly prior to the first run time measuring point the cache of the target processor used for executing the function is transformed into a predetermined state;
executing the control program on the target processor, wherein run time values are measured at the first and second run time measuring points from which the run time is determined.

2. The method of claim 1, wherein the function is a sub function which is executed within a higher-level function.

3. The method of claim 1, wherein the predetermined state represents a partially loaded cache.

4. The method of claim 3, wherein the partially loaded cache is mapped by statistical averaging over several runs, and the cache is emptied before the function is called in just a subset of runs.

5. The method of claim 3, wherein the partially loaded cache is mapped by inserting additional measuring code into the function to be measured.

6. The method of claim 1, wherein the predetermined state represents an empty cache.

7. The method of claim 1, wherein memory space outside the cache is assigned to the values to be measured at the run time measuring points.

8. A device for creating and executing a processor-in-the-loop (PIL) simulation for determining a run time that is needed by a function of a control program for a control unit in a real-time system while executed on a target processor in the PIL simulation, wherein the device comprises stored program code for:
creating or loading a graphical development model of the control unit in a development environment, wherein the graphical development model maps a functionality of the control unit using function blocks or function symbols;
selecting at least one function block or function symbol within the graphical development model via a graphical user interface;
automatically generating the control program for execution on the target processor in accordance with the graphical development model, wherein the control program includes the function which maps the functionality of the selected function block or function symbol;
transferring the generated control program to the target processor;
executing the control program on the target processor;
wherein the code generation inserts a first run time measuring point associated with the start of the function and a second run time measuring point associated with the end of the function into the control program and to put the cache of the target processor used for executing the function into a predetermined state directly prior to the first run time measuring point, and
receiving and analyzing the values measured at the run time measuring points during the execution of the control program.

9. The device of claim 8, wherein the code for analyzing the values measured at the run time measuring points is configured to annotate the function blocks or function symbols in the graphical development model with the analyzed run time values of the respective functions.

10. The device of claim 9, wherein the target processor is located on an evaluation board.

11. The method of claim 2, wherein the predetermined state represents a partially loaded cache.

12. The method of claim 2, wherein the predetermined state represents an empty cache.

13. The method of claim 2, wherein memory space outside the cache is assigned to the values to be measured at the run time measuring points.

14. The method of claim 3, wherein memory space outside the cache is assigned to the values to be measured at the run time measuring points.

15. The method of claim 4, wherein memory space outside the cache is assigned to the values to be measured at the run time measuring points.

16. The method of claim 5, wherein memory space outside the cache is assigned to the values to be measured at the run time measuring points.

17. The method of claim 6, wherein memory space outside the cache is assigned to the values to be measured at the run time measuring points.

18. The method of claim 11, wherein memory space outside the cache is assigned to the values to be measured at the run time measuring points.

19. The method of claim 12, wherein memory space outside the cache is assigned to the values to be measured at the run time measuring points.
